(19) United States
(12) Patent Application Publication
(10) Pub. No.: US 2010/0330416 A1
(43) Pub. Date: Dec. 30, 2010

(54) ELECTROLYTE INJECTION AND EXPLOSION PROOF DEVICE FOR USE IN POWER BATTERIES

(75) Inventors: Peng Wang, Dongguan city (CN); Feng-gang Zhao, Dongguan city (CN); Wei Chen, Dongguan city (CN); Xue-ze Wang, Dongguan city (CN)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignees: Dongguan Amperex Technology Limited; Dongguan Amperex Electronics Technology Limited

(21) Appl. No.: 12/820,778

(22) Filed: Jun. 22, 2010

(30) Foreign Application Priority Data
Jun. 24, 2009 (CN) 200920059056.9

(51) Int. Cl. H01M 2/08

(52) U.S. Cl. 429/185

(57) ABSTRACT

An electrolyte injection and explosion proof device for use in power batteries includes a cover defining an electrolyte injection hole, a rupture plate detachably disposed on the electrolyte injection hole, and an inner liner pressing the rupture plate on the electrolyte injection hole for sealing the same. The rupture plate detachably mounted on the electrolyte injection hole via pressing or clamping can be readily replaced, so that the power battery can be continuously used when the rupture plate is broken. Additionally, the explosion proof device is mounted on the electrolyte injection hole. The number of holes defined in the cover is reduced and the sealing performance of the power battery is remarkably improved.

### CROSS-REFERENCE TO RELATED APPLICATION

The present patent application claims the benefit of Chinese Patent Application No. 200920059056.9, filed Jun. 24, 2009, the disclosure of which is hereby incorporated herein by reference in its entirety.

### FIELD OF THE INVENTION

The present patent application generally relates to power batteries and, more particularly, relates to an electrolyte injection and explosion proof device for use in power batteries.

### BACKGROUND OF THE INVENTION

With increasing popularization of power batteries, especially power batteries with high capacity, more and more attentions have been paid to the safety performance of the power batteries.

Conventionally, most of the power batteries defines an explosion proof hole at a cover thereof. An explosion proof plate made of copper foil is soldered on the explosion proof hole for sealing the same. When the air pressure in the power battery exceeds a predetermined value, the air will rupture the copper foil to prevent the power battery from exploding due to high air pressure therein. To prevent the copper foil from being pierced or damaged by mistake, a protecting shield defining holes therein is generally provided on the copper foil. During the manufacturing process of the power battery, the cover is provided with an additional electrolyte injection hole. The electrolyte injection hole is sealed after the electrolyte is injected into the power battery, so as to safely insulate the inner side of the power battery from the outer surroundings.

However, the respectively defined electrolyte injection hole and the explosion proof hole will inevitably reduce the sealing performance of the power battery. Moreover, the copper foil is attached to the cover of the power battery via soldering process. When the copper foil is broken or ruptured, it is difficult to replace the broken copper foil with a new one. Therefore, once the copper foil is broken or cannot work properly, the power battery cannot be used any more.

What is needed, therefore, is to provide a replaceable electrolyte injection and explosion proof device with desirable sealing performance for use in power batteries.

### SUMMARY OF THE INVENTION

One object of the present invention is to provide a replaceable electrolyte injection and explosion proof device with desirable sealing performance for use in power batteries.

According to one embodiment of the present invention, an electrolyte injection and explosion proof device for use in power batteries includes: a cover defining an electrolyte injection hole, a rupture plate detachably disposed on the electrolyte injection hole, and an inner liner pressing the rupture plate on the electrolyte injection hole for sealing the same.

In accordance with one embodiment of the present invention, the rupture plate of the electrolyte injection and explosion proof device is detachably mounted on the electrolyte injection hole. The broken rupture plate can be readily replaced by a new one, such that the power battery can be continuously used. Additionally, the explosion proof device in accordance with the embodiments of the present invention is mounted on the electrolyte injection hole. The number of holes in the cover is reduced and the sealing performance of the power battery is remarkably improved.

According to one aspect of the present invention, the electrolyte injection and explosion proof device further includes an injection encapsulation disposed in the electrolyte injection hole, an outer liner having a supporting portion safely positioned in the injection encapsulation and an inner gasket. The rupture plate and the inner gasket are disposed in the outer liner and supported by the supporting portion, and the inner liner is secured to the outer liner for tightly pressing the inner gasket and the rupture plate on the electrolyte injection hole.

According to one aspect of the present invention, the inner liner and the outer liner are coupled to each other via threaded connection or interference fit.

According to one aspect of the present invention, the inner gasket defines an annular recess for safely receiving the inner gasket The inner gasket is tightly sandwiched between the inner liner and the supporting portion of the outer liner.

According to one aspect of the present invention, the inner gasket is formed in an annular shape and has a circular-shaped or square-shaped cross section.

According to one aspect of the present invention, the electrolyte injection and explosion proof device further includes an injection encapsulation having a through-hole and forming a supporting portion seated in the electrolyte injection hole and an inner gasket. The rupture plate as well as the inner gasket are situated in the through-hole and supported by the supporting portion. The inner liner is disposed in the through-hole of the injection encapsulation for tightly pressing the inner gasket and the rupture plate on the electrolyte injection hole.

According to one aspect of the present invention, the electrolyte injection and explosion proof device includes an inner gasket. The cover forms a supporting portion under the electrolyte injection hole. The rupture plate with the inner gasket disposed thereon is securely sandwiched between the inner liner and the supporting portion.

According to one aspect of the present invention, the electrolyte injection and explosion proof device further includes an injection encapsulation disposed in the electrolyte injection hole and an outer liner having a supporting portion securely seated in the injection encapsulation. The rupture plate is seated in the outer liner and supported by the supporting portion. The inner liner is secured to the outer liner for tightly pressing the rupture plate on the electrolyte injection hole.

According to one aspect of the present invention, the rupture plate defines a groove at an upper surface thereof.

According to one aspect of the present invention, the rupture plate is integrally formed with the inner liner, or coupled to the inner liner via soldering.

Other advantages and novel features will be drawn from the following detailed description of preferred embodiments with the attached drawings. The accompanying drawings, which are incorporated in and constitute a part of this specification, illustrate embodiments of the present invention and, together with a general description of the invention given above, and the detailed description of the embodiments given below, serve to explain the principles of the invention:

### BRIEF DESCRIPTION OF THE DRAWINGS

FIG. 1 depicts a perspective view of a power battery having an electrolyte injection and explosion proof device assembled thereon according to one embodiment of the present invention;

FIG. 2 depicts an exploded view of an electrolyte injection and explosion proof device for use in a power battery according to a first embodiment of the present invention;

FIG. 3 depicts a cross-sectional view of the electrolyte injection and explosion proof device in assembly as shown in FIG. 2;

FIG. 4 depicts an enlarged view of a circled portion A as shown in FIG. 3;

FIG. 5 is similar to FIG. 4, depicting an enlarged cross-sectional view of an electrolyte injection and explosion proof device for use in a power battery according to a second embodiment of the present invention;

FIG. 6 is similar to FIG. 4, depicting an enlarged cross-sectional view of an electrolyte injection and explosion proof device for use in a power battery according to a third embodiment of the present invention;

FIG. 7 is similar to FIG. 4, depicting an enlarged cross-sectional view of an electrolyte injection and explosion proof device for use in a power battery according to a fourth embodiment of the present invention;

FIG. 8 is similar to FIG. 4, depicting an enlarged cross-sectional view of an electrolyte injection and explosion proof device for use in a power battery according to a fifth embodiment of the present invention;

FIG. 9 is similar to FIG. 4, depicting an enlarged cross-sectional view of an electrolyte injection and explosion proof device for use in a power battery according to a sixth embodiment of the present invention;

FIG. 10 is similar to FIG. 4, depicting an enlarged cross-sectional view of an electrolyte injection and explosion proof device for use in a power battery according to a seventh embodiment of the present invention;

FIG. 11 is similar to FIG. 4, depicting an enlarged cross-sectional view of an electrolyte injection and explosion proof device for use in a power battery according to a eighth embodiment of the present invention; and

FIG. 12 is similar to FIG. 4, depicting an enlarged cross-sectional view of an electrolyte injection and explosion proof device for use in a power battery according to a ninth embodiment of the present invention.

### DETAILED DESCRIPTION OF THE INVENTION

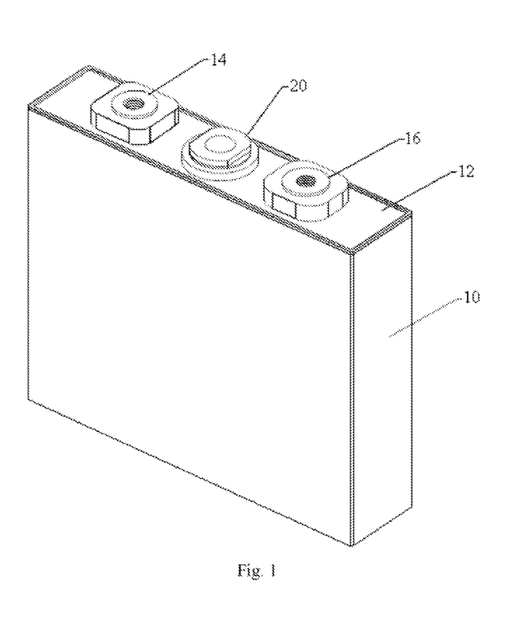

Referring particularly to FIG. 1, a power battery with an electrolyte injection and explosion proof device according to one embodiment of the invention includes a can housing 10, a battery cell (not shown) accommodated in the can housing 10, electrolyte (not shown) filled in the can housing 10, and a cover 12 assembled on the top of the can housing 10 for sealing the same. The cover 12 is provided with an electrolyte injection and explosion proof device 20 at a center thereof. A positive pole 14 and a negative pole 16 are seated at two sides of the electrolyte injection and explosion proof device 20.

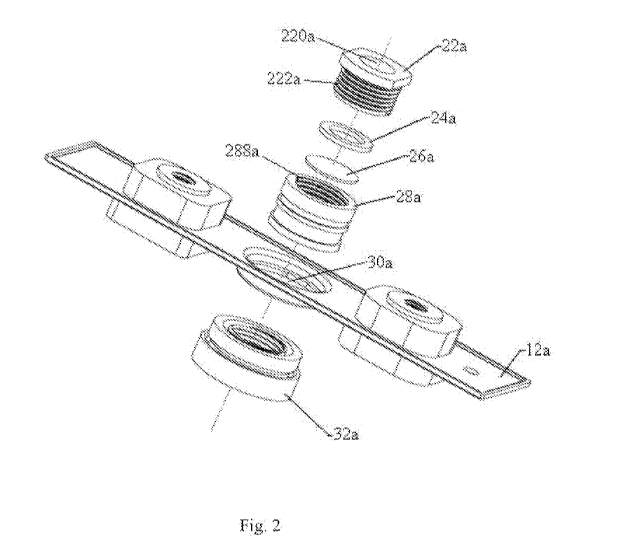

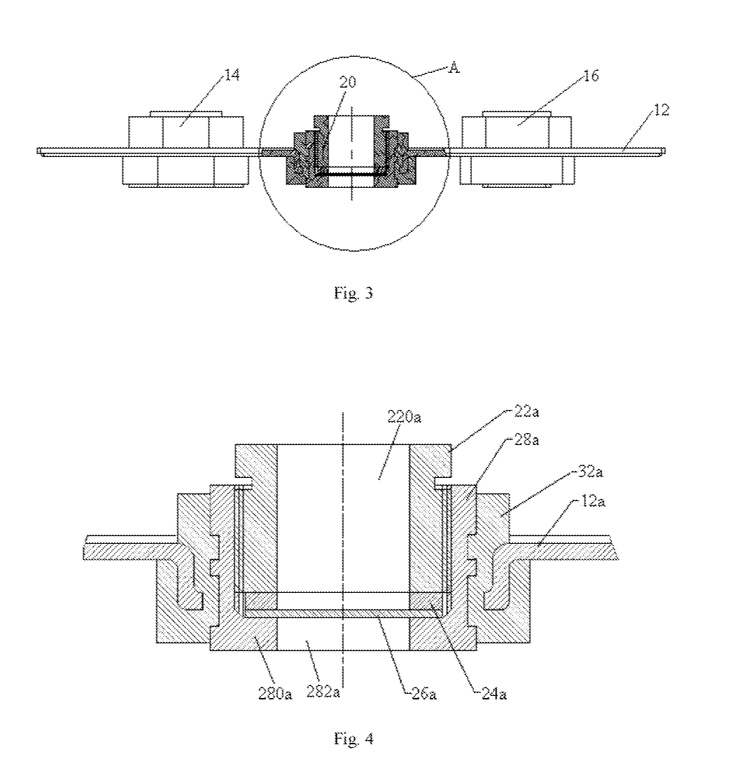

Referring to FIG. 2 to FIG. 4, the electrolyte injection and explosion proof device 20 according to a first embodiment of the present invention includes an inner liner 22a, an inner gasket 24a, a rupture plate 26a, an outer liner 28a, an electrolyte injection hole 30a defined in the cover 12a, and an injection encapsulation 32a.

The inner liner 22a defines a through hole 220a extending therethrough. Outer surface of the inner liner 22a defines an external thread 222a. The inner gasket 24a is formed in an annular shape and has an inner diameter and outer diameter corresponding to the inner diameter and outer diameter of the inner liner 22a. The rupture plate 26a is a circular planar plate which has a diameter corresponding to the outer diameter of the inner gasket 22a. Inner side wall of the outer liner 28a defines an internal thread 288a which can engage the external thread 222a of the inner liner 22a. A supporting portion 280a for supporting the inner gasket 26a is provided at a lower portion of the outer liner 28a. The supporting portion 280a defines a through-hole 282a having a diameter equal to the diameter of the through hole 220a of the inner liner 22a at a center thereof. The injecting encapsulation 32a and the outer liner 28a are firmly fixed to each other via engagement between the protrusion(s) or recess(s) on the outer side wall of the outer liner 28a and corresponding recess(s) or protrusion(s) on the inner side wall of the injecting encapsulation 32a. Outer wall of the injection encapsulation 32a is bent to cover part of the cover 12a around the electrolyte injection hole 30a and firmly couple the injection encapsulation 32a to the cover 12a.

During the manufacturing of the power battery, the electrolyte is injected into the can housing 10 via the electrolyte injection hole 30a. The cover 12a together with the outer liner 28a is put in the injection mould for injection molding. The plastic is injected into the space between the cover 12a and the outer liner 28a, so as to form the injection encapsulation 32a and couple the outer liner 28a to the cover 12a. The rupture plate 26a and the inner gasket 24 are successively set in the outer liner 28a and supported by the supporting portion 280a. The inner liner 22a is screwed into the outer liner 28a via the engagement of the outer thread 222a and the inner thread 288a, to sandwich the rupture plate 26a and the inner gasket 24a tightly between the inner liner 22a and the outer liner 28a. In this case, the electrolyte injection hole 30a is safely sealed.

In use, when the air pressure in the power battery exceeds a predetermined value, the rupture plate 26a will break and the air will vent into the surroundings via the through hole 220a defined in the inner liner 22a, so as to prevent the power battery from exploding because of high air pressure. When the air pressure inside the power battery is released, the inner liner 22a can be unscrewed and disengaged from the outer liner 28a. The broken rupture plate 26a can be replaced by a new one. The power battery can be used again. It should be noticed that, the predetermined value of the air pressure can be adjusted via adjusting the thickness of the rupture plate 26a or selecting different types of materials according to actual requirement.

FIG. 5 depicts a cross-sectional view of an electrolyte injection and explosion proof device for use in a power battery according to a second embodiment of the present invention, which includes an inner liner 22b, an inner gasket 24b, a rupture plate 26b, an outer liner 28b, an electrolyte injection hole (not shown) defined in the cover 12b and an injecting encapsulation 32b. Differing from the first embodiment of the present invention, according to the second embodiment of the present invention, the inner liner 22b and the outer liner 28b are securely coupled to each other via interference fit, instead of threaded connection.

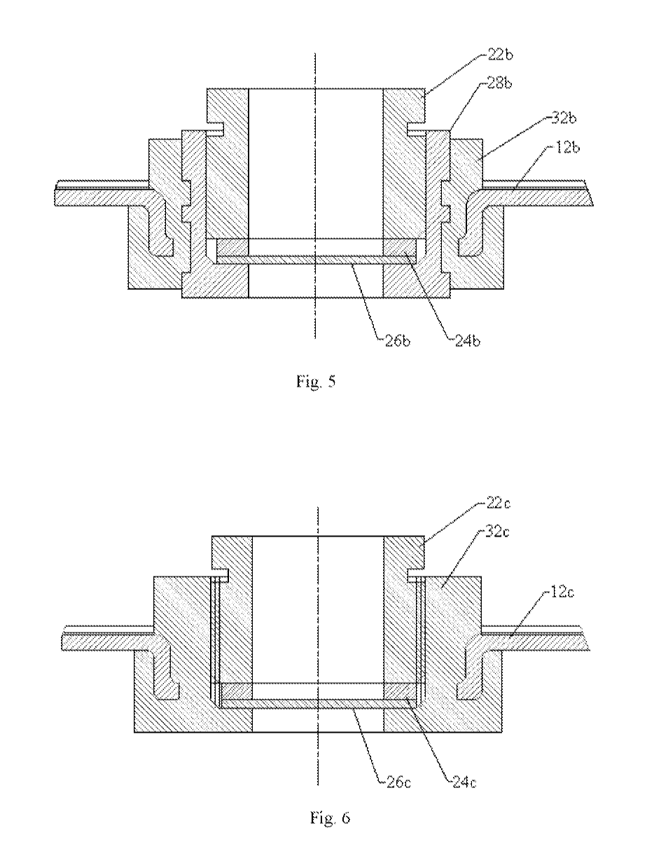

FIG. 6 depicts a cross-sectional view of an electrolyte injection and explosion proof device for use in a power battery according to a third embodiment of the present invention, which includes an inner liner 22c, an inner gasket 24c, a rupture plate 26c, an electrolyte injecting hole (not shown) in the cover 12c and an injection encapsulation 32c. Differing from the first embodiment of the present invention, according to the third embodiment of the present invention, the outer liner 28a and the injection encapsulation 32a of the first embodiment of the present invention are combined as one element, i.e. the injection encapsulation 32c. In this case, the injection encapsulation 32c accommodates the inner liner 24c and the rupture plate 26c therein, and the inner liner 22c is connected to the injection encapsulation 32c.

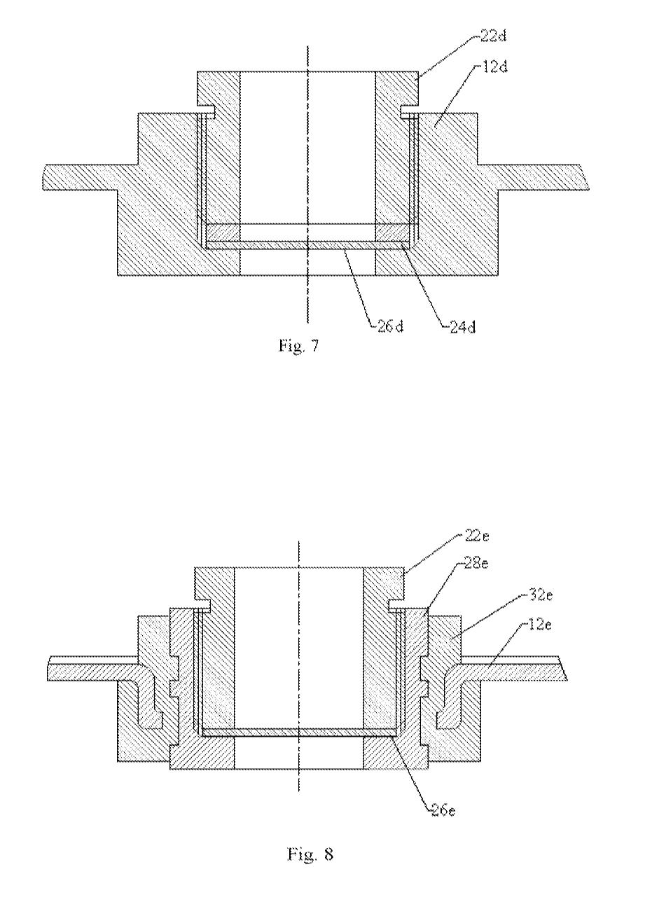

FIG. 7 depicts a cross-sectional view of an electrolyte injection and explosion proof device for use in a power battery according to a fourth embodiment of the present invention, which includes an inner liner 22d, an inner gasket 24d, a rupture plate 26d and a cover 12d defining an electrolyte injection hole (not shown). Differing from the first embodiment of the present invention, according to the fourth embodiment of the present invention, the outer liner 28a, the injection encapsulation 32a and the cover 12a as shown in the first embodiment of the present invention are combined as one element, i.e. the cover 12d. In this case, the inner gasket 24d and the rupture plate 26d are safely received in the cover 12d, and the inner liner 22d are connected to the cover 12d via interference fit or threaded connection.

FIG. 8 depicts a cross-sectional view of an electrolyte injection and explosion proof device for use in a power battery according to a fifth embodiment of the present invention, which includes an inner liner 22e, a rupture plate 26e, an outer liner 28e, an electrolyte injection hole (not shown) in the cover 12e and an injection encapsulation 32e. Differing from the first embodiment of the present invention, in accordance with the fifth embodiment of the present invention, there is no arrangement of the inner gasket 24a as shown in the first embodiment of the present invention. The inner liner 22e directly abuts against the upper surface of the rupture plate 26e.

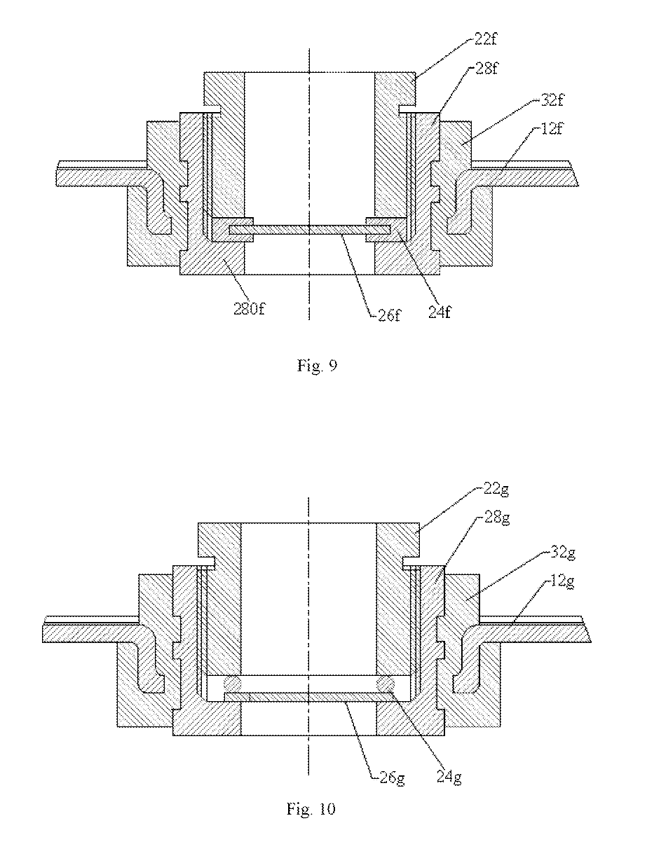

FIG. 9 depicts a cross-sectional view of an electrolyte injection and explosion device for use in a power battery in accordance with a sixth embodiment of the present invention, which includes an inner liner 22f, an inner gasket 24f, a rupture plate 26f, an outer liner 28f, an electrolyte injection hole (not shown) defined in the cover 12f and an injection encapsulation 32f. Differing from the first embodiment of the present invention, according to the sixth embodiment of the present invention, the inner gasket 24f defines an annular recess (not labeled) having a diameter corresponding to the diameter of the rupture plate 26f in the inner side wall thereof. The rupture plate 26f is safely positioned in the recess defined in the inner gasket 24f. In this case, the inner gasket 24f is tightly sandwiched between the inner liner 22f and the supporting portion 280f of the outer liner 28f, thereby sealing the electrolyte injection hole.

FIG. 10 depicts a cross-sectional view of an electrolyte injection and explosion proof device for use in a power battery according to a seventh embodiment of the present invention, which includes an inner liner 22g, an inner gasket 24g, a rupture plate 26g, an outer liner 28g, an electrolyte injection hole (not shown) defined in the cover 12g and an injection encapsulation 32g. Differing from the first embodiment of the present invention, according to the seventh embodiment of the present invention, the inner gasket 24g has a circular-shaped cross section.

FIG. 11 depicts a cross-sectional view of an electrolyte injection and explosion proof device for use in a power battery according to a eighth embodiment of the present invention, which includes an inner liner 22h, an inner gasket 24h, a rupture plate 26h, an outer liner 28h, an electrolyte injecting hole (not shown) defined in the cover 12h and an injection encapsulation 32h. Differing from the first embodiment of the present invention, according to the eighth embodiment of the present invention, the rupture plate 26h is provided with a groove 260h at an upper surface thereof. When the air pressure in the power battery exceeds a predetermined value, the rupture plate 26h will break along the groove 260h.

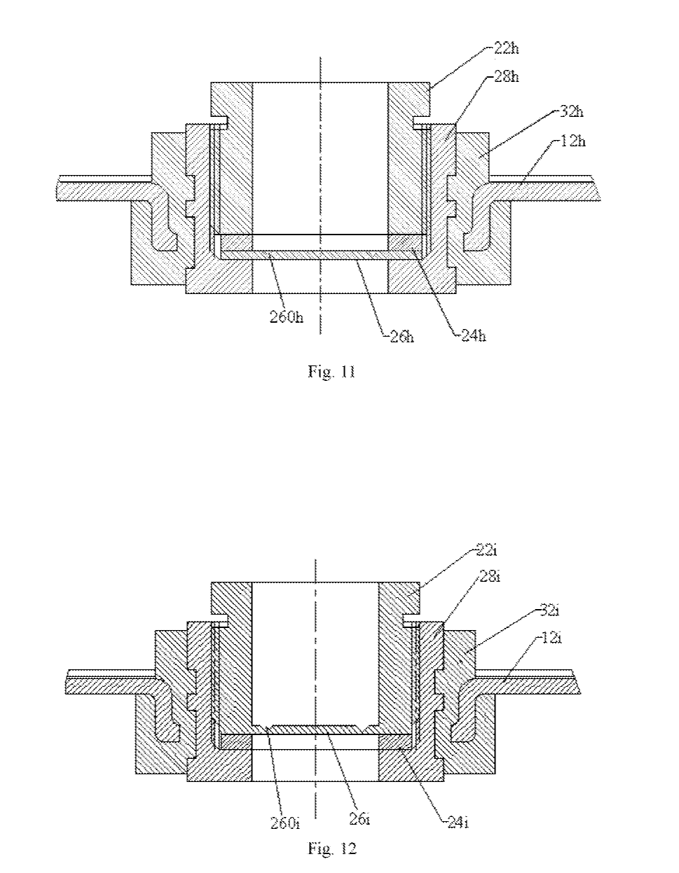

FIG. 12 depicts a cross-sectional view of an electrolyte injection and explosion proof device for use in a power battery according to a ninth embodiment of the present invention, which includes an inner liner 22i, an inner gasket 24i, a rupture plate 26i, an outer liner 28i, an electrolyte injecting hole (not shown) defined in the cover 12i and an injection encapsulation 32i. Differing from the first embodiment of the present invention, in accordance with the ninth embodiment of the present invention, the rupture plate 26i is integrally formed with the inner liner 22i via mechanical machining or coupled to the inner liner 22i via soldering process. The inner gasket 24i is firmly sandwiched between the rupture plate 26i and the outer liner 28i. Additionally, the rupture plate 26i is provided with a groove 260i at an upper surface thereof. When the air pressure in the power battery exceeds a predetermined value, the rupture plate 26i will rupture along the groove 260i. The broken inner liner 22i can be replaced by a new one, so that the power battery can be used again.

The installation process and function principle of the electrolyte injection and explosion proof device according to the second embodiment to the ninth embodiment of the present invention are similar to that of the first embodiment of the present invention and, therefore, will not be detailed again. It should be noticed that, in the embodiments as illustrated, the inner liner 22 and the outer liner 28 are both made from metal material because the metal material has desirable strength and can be manufactured easily. However, according to other embodiment of the present invention, the inner liner 22 and the outer liner 28 can also be made from other material which has desirable strength and can be manufactured easily.

According to embodiments of the present invention, the rupture plate of the electrolyte injection and explosion proof device for use in power batteries is detachably mounted on the electrolyte injection hole via pressing or clamping. The broken rupture plate can be readily replaced by a new one, so that the power battery can be continuously used. Additionally, the explosion proof device according to the embodiments of the present invention is mounted on the electrolyte injection hole. The number of holes in the cover is reduced and the sealing performance of the power battery is remarkably improved.

While the present invention has been illustrated by the above description of the preferred embodiments thereof, while the preferred embodiments have been described in considerable detail, it is not intended to restrict or in any way to limit the scope of the appended claims to such details. Additional advantages and modifications within the spirit and scope of the present invention will readily appear to those ordinary skilled in the art. Consequently, the present invention is not limited to the specific details and the illustrative examples as shown and described.

What is claimed is:

1. An electrolyte injection and explosion proof device for use in power batteries, the electrolyte injection and explosion proof device comprising:
a cover defining an electrolyte injection hole,
a rupture plate detachably disposed on the electrolyte injection hole; and
an inner liner pressing the rupture plate on the electrolyte injection hole for sealing the same.

2. The electrolyte injection and explosion proof device of claim 1, further comprising an injection encapsulation disposed in the electrolyte injection hole, an outer liner having a supporting portion securely positioned in the injection encapsulation and an inner gasket, wherein the rupture plate and the inner gasket is seated in the outer liner and supported by the supporting portion, the inner liner is secured to the outer liner for tightly pressing the inner gasket and the rupture plate on the electrolyte injection hole.

3. The electrolyte injection and explosion proof device of claim 2, wherein the inner liner and the outer liner are coupled to each other via threaded connection or interference fit.

4. The electrolyte injection and explosion proof device of claim 2, wherein the inner gasket defines an annular recess for safely receiving the inner gasket, and the inner gasket is tightly sandwiched between the inner liner and the supporting portion of the outer liner.

5. The electrolyte injection and explosion proof device of claim 2, wherein the inner gasket is formed in an annular shape and has a circular-shaped or square-shaped cross section.

6. The electrolyte injection and explosion proof device of claim 1, further comprising an injection encapsulation defining a through-hole and forming a supporting portion seated in the electrolyte injection hole and an inner gasket, wherein the rupture plate and the inner gasket are situated in the through-hole and supported by the supporting portion, the inner liner is set in the through-hole of the injection encapsulation for tightly pressing the inner gasket and the rupture plate on the electrolyte injection hole.

7. The electrolyte injection and explosion proof device of claim 1, further comprising an inner gasket, wherein the cover forms a supporting portion under the electrolyte injection hole, and the rupture plate with the inner gasket disposed thereon is securely sandwiched between the inner liner and the supporting portion.

8. The electrolyte injection and explosion proof device of claim 1, further comprising an injection encapsulation disposed in the electrolyte injection hole and an outer liner having a supporting portion securely seated in the injection encapsulation, wherein the rupture plate is seated in the outer liner and supported by the supporting portion, the inner liner is secured to the outer liner for tightly pressing the rupture plate on the electrolyte injection hole.

9. The electrolyte injection and explosion proof device of claim 1, wherein the rupture plate defines a groove at an upper surface thereof.

10. The electrolyte injection and explosion proof device of claim 1, wherein the rupture plate is integrally formed with the inner liner, or coupled to the inner liner via soldering.

11. A power battery comprising a cover defining an electrolyte injection hole, wherein the electrolyte injection hole is sealed by a rupture plate detachably assembled thereon.

12. The power battery of claim 11, wherein the rupture plate tightly seals the electrolyte injection hole by a liner via interference fit or threaded connection.

13. The power battery of claim 12, wherein the rupture plate is integrally formed with the liner or attached to the inner liner via soldering.

14. The power battery of claim 11, wherein the rupture plate defines a groove at an upper surface thereof.

15. The power battery of claim 11, further comprising an injection encapsulation defining a through hole therein corresponding to the electrolyte injection hole fixed on the cover, wherein the rupture plate sealing the electrolyte injection hole is sandwiched between the inner liner and the injection encapsulation.

16. An explosion proof device for use in a cover of a power battery having an electrolyte injection hole, comprising: a liner detachably secured to the cover and a rupture plate for safely sealing the electrolyte injection hole tightly sandwiched between the liner and the cover.

17. The explosion proof device of claim 16, wherein the liner is secured to the cover via interference fit or threaded connection.

18. The explosion proof device of claim 16, wherein the rupture plate is integrally formed with the liner or attached to the liner via soldering.

19. The explosion proof device of claim 16, wherein the rupture plate defines a groove at an upper surface thereof.
